(19) United States
(12) Patent Application Publication
(10) Pub. No.: US 2015/0143974 A1
(43) Pub. Date: May 28, 2015

(54) Guitar String Regulator

(71) Applicant: Bum-Jin Kim, Seoul (KR)

(72) Inventor: Bum-Jin Kim, Seoul (KR)

(21) Appl. No.: 13/635,327

(22) PCT Filed: Aug. 6, 2012
(86) PCT No.: PCT/KR12/06224

§ 371 Date: Sep. 14, 2012

(30) Foreign Application Priority Data
Aug. 22, 2011 (KR) 10-2011-0083249

(51) Int. Cl. G10D 3/14

(52) U.S. Cl. CPC G10D 3/14
USPC 84/455

(57) ABSTRACT

Disclosed therein is a guitar string regulator. The guitar string regulator includes: a regulating lever (12) having a worm gear part (11) disposed at one side thereof; a casing (14) having a joining tube (14b), which has a male screw portion (14a) penetrating through the head (5), and a bearing portion (14c) formed on a lower portion thereof for receiving the worm gear part (11) and supporting rotation, of the worm gear part (11); a rotational rod (15) penetrating through the casing (14) and having a winding portion (15a), which is concavely formed at one side thereof for winding a string, a guide hole (15b), which is formed in the winding portion (15) and penetrates through the joining tube (14b) for inserting the string (W) thereinto, and a spur gear (15c), which is disposed at a lower portion thereof for rotating the rotational rod (15) in engagement with the worm gear part (11); and a nut (16) joined to the male screw portion (14a) of the casing (14) for fixing the casing (14) from the head (5), wherein the rotational rod (15) has a through hole (15d) formed at the center of the rotational rod (15) for inserting the remainder of the string (W) wound on the winding portion (15a) thereinto, The guitar string regulator can prevent interference by the cut end of the string, prevent the player from getting scratched or pricked by the cut end of the string, and can always make the head part of the guitar clean because the cut end of the string of the guitar is guided into the through hole formed in the rotational rod as soon as the string is cut close below the case after the remainder of the string penetrates through the through hole of the rotational rod.

### TECHNICAL FIELD

The present invention relates to a guitar string regulator, and more particularly, to a guitar string regulator, which is capable of cleanly arranging the remainder of strings after strings of the guitar are set so as to prevent interference among the strings and prevent a player from being injured by ends of the strings.

### BACKGROUND ART

As people know, guitars are the most popularized out of string instruments, and FIG. 1 illustrates an example of the guitar.

The guitar 1 includes a bridge 3 disposed at a sound box 2, a fingerboard 4 combined from the sound box 2, a head 5 disposed at one side of the fingerboard 4, and a guitar string regulator 10 mounted on the head 5 for regulating strings (W).

The guitar string regulator 10 is a device for tuning pitch of each string by regulating tension force of the guitar strings are fixed. As shown in FIG. 2, the guitar string regulator 10 is mounted on the head 5 of the guitar 1 and includes: a regulating lever 12 having a worm gear part 11 disposed at one side thereof; a casing 14 having a joining tube 14b, which has a male screw portion 14a penetrating through the head 5, and a bearing portion 14c formed on a lower portion thereof for receiving the worm gear part 11 and supporting rotation, of the worm gear part 11; a rotational rod 15 penetrating through the casing 14 and having a winding portion 15a, which is concavely formed at one side thereof for winding a string, a guide hole 15b, which is formed in the winding portion 15 and penetrates through the joining tube 14b for inserting the string W thereinto, and a spur gear 15c, which is disposed at a lower portion thereof for rotating the rotational rod 15 in engagement with the worm gear part 11; and a nut 16 joined to the male screw portion 14a of the casing 14 for fixing the casing 14 from the head 5.

According to the guitar string regulator 10 having the above structure, when the string W penetrates into the guide hole 15b of the rotational rod 15 and the regulating lever 12 is rotated, the spur gear 15 is rotated by the worm gear part 11 and the rotational rod 15 is rotated by the spur gear 15c, and then, the string 15a is wound on the winding portion 15a while tension force is applied to the string.

The remainder of the string W wound on the winding portion 15a is left as it is or is wound up on the tensed string twice or three times within a section of the head 5 before a start of the fingerboard and cut by a nipper.

However, the method of winding up the remainder of the string on the tensed string influences on the twangy tone of the string, the remainder of the string must be cut by the nipper as close as possible.

In the majority of cases, when the string is forcedly cut, because the end portion of the string gets sharp, the player frequently gets pricked or scratched while handling the head of the guitar or the case for receiving the guitar or playing the guitar.

As described above, because the guitar strings are made of high carbon steel, it is not easy to cut them and the player has to pay attention due to the sharp cut portion of

### DISCLOSURE

### Technical Problem

Accordingly, the present invention has been made in an effort to solve the above-mentioned problems occurring in the prior arts, and it is an object of the present invention to provide a guitar string regulator, which is capable of cleanly arranging the remainder of strings after strings of the guitar are set so as to prevent interference among the strings and prevent a player from being injured by ends of the strings.

### Technical Solution

To achieve the above objects, the present invention provides a plurality of guitar string regulators, which are mounted on a head of a guitar, and each of which includes a regulating lever having a worm gear part disposed at one side thereof a casing having a joining tube, which has a male screw portion penetrating through the head, and a bearing portion formed on a lower portion thereof for receiving the worm gear part and supporting rotation of the worm gear part; a rotational rod penetrating through the casing and having a winding portion, which is concavely formed at one side thereof for winding a string, a guide hole, which is formed in the winding portion and penetrates through the joining tube for inserting the string thereinto, and a spur gear, which is disposed at a lower portion thereof for rotating the rotational and in engagement with the worm gear part; and a nut joined to the male screw portion of the casing for fixing the casing from the head, wherein the rotational rod has a through hole formed at the center of the rotational rod for inserting the remainder of the string wound on the winding portion thereinto.

Moreover, the through hole is twice the diameter of the guide hole such that the remainder of the string inserted into the through hole is intersected relative to the string inserted into the guide hole of the winding portion.

### Advantageous Effects

As described above, the guitar string regulator according to the present invention can prevent interference by the cut end of the string, prevent the player from getting scratched or pricked by the cut end of the string, and can always make the head part of the guitar clean because the cut end of the string of the guitar is guided into the through hole formed in the rotational rod as soon as the string is cut close below the case after the remainder of the string penetrates through the through hole of the rotational rod.

### DESCRIPTION OF DRAWINGS

FIG. 1 is a perspective view of a general acoustic guitar.

FIG. 2 is a perspective view of a guitar string regulator according to a prior art.

FIG. 3 is a vertically sectional view of the guitar string regulator according to the prior art.

FIG. 4 is a perspective view of a guitar string regulator according to the present invention.

FIGS. 5 to 7 are vertically sectional views showing a used state of the guitar string regulator according to the present invention.

### MODE FOR INVENTION

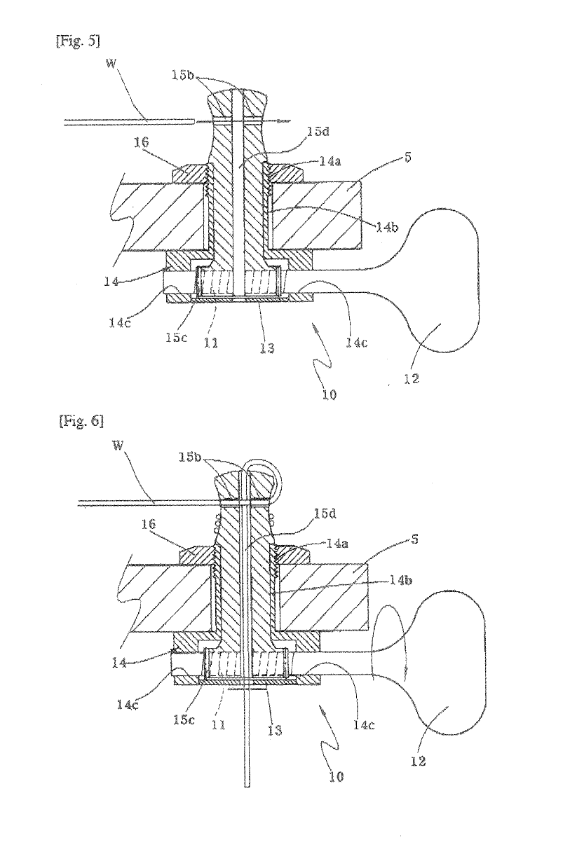

Referring to FIGS. 4 to 7, a guitar string regulator according to the present invention will be described in detail as follows.

A plurality of the guitar string regulators according to the present invention are mounted on a head of a guitar, and each of the guitar string regulators includes: a regulating lever 12 having a worm gear part 11 disposed at one side thereof; a casing 14 having a joining tube 14b, which has a male screw portion 14a penetrating through the head 5, and a bearing portion 14c formed on a lower portion thereof for receiving the worm gear part 11 and supporting rotation of the worm gear pert 11; a rotational rod 15 penetrating through the casing 14 and having a winding portion 15a, which is concavely formed at one side thereof for winding a string, a guide hole 15b, which is formed in the winding portion 15 and penetrates through the joining tube 14b for inserting the string W thereinto, and a spur gear 15c, which is disposed at a lower portion thereof for rotating the rotational red 15 in engagement with the worm gear part 11; and a nut 16 joined to the male screw portion 14a of the casing 14 for fixing the casing 14 from the head 5.

The rotational rod 15 has a through hole 15d formed at the center of the rotational rod 15 for inserting the remainder of the string W wound on the winding portion 15a thereinto.

The through hole 15d is twice the diameter of the guide hole 15b such that the remainder of the string W inserted into the through hole 15d is intersected relative to the string W inserted into the guide hole 15b of the winding portion 15a.

In the drawings, unexplained reference numeral 14 designates a stopper for stopping the bottom of the case 14.

Now, how to set the string and arrange the remainder of the string using the guitar string regulator will be described.

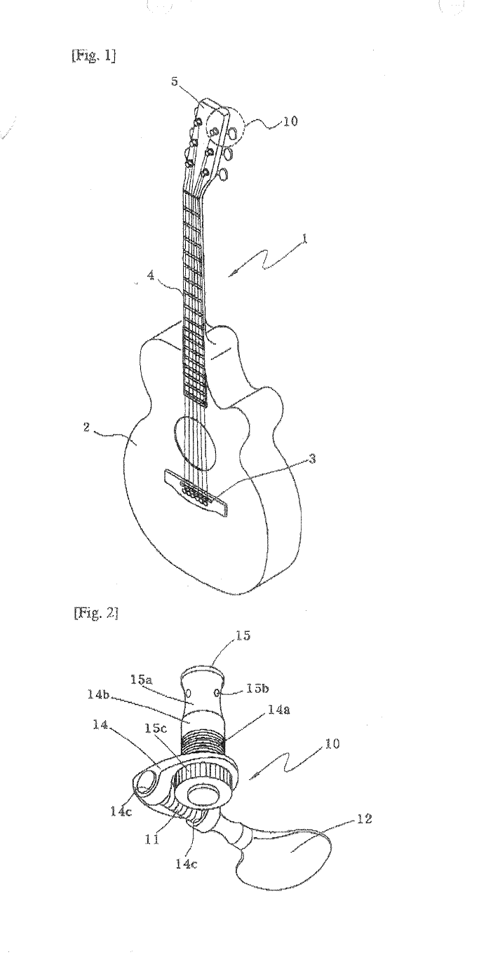

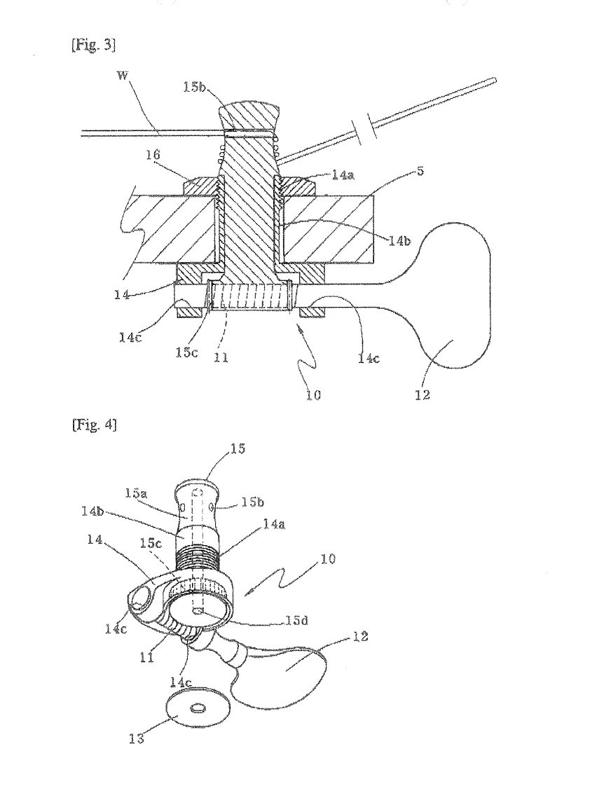

Referring to FIG. 1, a ring-shaped end of a string W is first connected to a bridge 3 of a guitar 1, and then, the other end of the string is set to the guitar string regulator 10 disposed on the head 5 of the guitar after passing through the fingerboard 4.

The above is the same as the guitar string regulator according to the prior art. After that, as shown in FIG. 5, the string W penetrates through the guide hole 15b of the rotational rod 15, and then, the regulating lever 12 is rotated in a state where a player holds the string passing through the guide hole 15b with the hand.

The worm gear part 11 mounted on the bearing portion 14c the case 14 is geared with the spur gear 15c of the rotational rod, and then, the string W is wound on the winding portion 15a in a state where tension force is applied to the string while the rotational rod 15 is rotated.

In this instance, the rotational rod 15 is rotated inside the joining tube 14b of the case 14.

For your reference, the joining tube 14b is joined to the male screw portion 14a through the head 5 by the nut 16 so that the case 14 is firmly fixed to the head 5. Here, only the rotational rod 15 is rotated inside the joining tube 14b so that the string W can be wound in one direction as to wind up the string W on the winding portion 15a more tightly. In this instance, when the string W is wound on the winding portion 15a from the guide hole, the string penetrating through the guide hole 15b and the string wound on the winding portion once are crossed.

Finally, after six strings are arranged as the above before tones of the strings W are tuned, as shown in FIG. 6, the remainder of the string is inserted into the through hole 15d of the rotational rod 15 till completely passing through the through hole 15d.

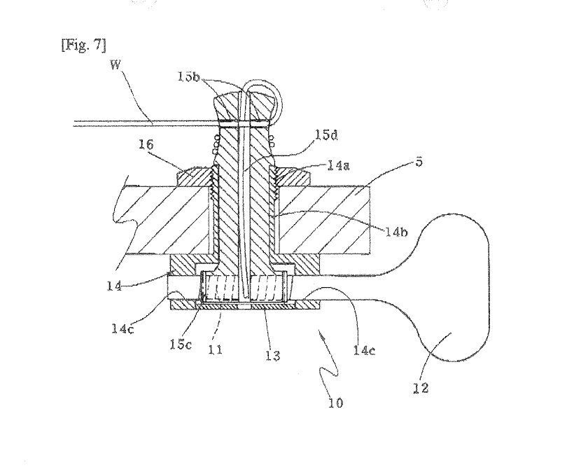

As described above, when the string passing through the lower portion of the rotational rod 15, namely, through the center of the spur gear, is cut close beneath the spur gear 15c using a nipper (not shown) in a state where the string is pulled as much as possible, as shown in FIG. 7, the end portion of the string W keeps the state where it is inserted into the through hole 15d by elasticity.

The string W arranged as the above is arranged more neatly in external appearance by the stopper 13 mounted on the bottom of the case 14.

Accordingly, because the end portions of the strings W are all arranged neatly, the guitar string regulator according to the present invention can prevent interference by the strings protruding roughly like the traditional way and prevent the player from getting pricked or scratched by the sharp end portion of the strings while the player handles the guitar.

1. A plurality of guitar string regulators, which are mounted on a head of a guitar, each of which include:
a regulating lever (12) having a worm gear part (11) disposed at one side thereof; a casing (14) having a joining tube (14b), which has a male screw portion (14a) penetrating through the head (5), and a bearing portion (14c) formed on a lower portion thereof for receiving the worm gear part (11) and supporting rotation of the worm gear part (11); a rotational rod (15) penetrating through the casing (14) and having a winding portion (15a), which is concavely formed at one side thereof for winding a string, a guide hole (15b), which is formed in the winding portion (15) and penetrates through the joining tube (14b) for inserting the string (W) thereinto, and a spur gear (15c), which is disposed at a lower portion thereof for rotating the rotational rod (15) in engagement with the worm gear part (11); and a nut (16) joined to the male screw portion (14a) of the casing (14) for fixing the casing (14) from the head (5),
wherein the rotational rod (15) has a through hole (15d) formed at the center of the rotational rod (15) for inserting the remainder of the string (W) wound on the winding portion (15a) thereinto.

2. The guitar string regulator according to claim 1, wherein the through hole (15d) is twice the diameter of the guide hole (15b) such that the remainder of the string (W) inserted into the through hole (15d) is intersected relative to the string (W) inserted into the guide hole (15b) of the winding portion (15a).
